(19) United States
(12) Patent Application Publication
(10) Pub. No.: US 2021/0354382 A1
(43) Pub. Date: Nov. 18, 2021

(54) FRAMELESS 3D-PRINTING SYSTEM

(71) Applicant: Collin Boring, Walnut Creek, CA (US)

(72) Inventor: Collin Boring, Walnut Creek, CA (US)

(21) Appl. No.: 17/320,237

(22) Filed: May 14, 2021

Related U.S. Application Data
(60) Provisional application No. 63/024,632, filed on May 14, 2020.

(51) Int. Cl. B29C 64/232; B29C 64/255; B29C 64/321; B29C 64/245; B29C 64/209; B29C 64/236; B29C 64/295; B29C 64/25; B33Y 30/00

(52) U.S. Cl. CPC B29C 64/232; B29C 64/255; B29C 64/321; B29C 64/245; B29C 64/118; B29C 64/236; B29C 64/295; B29C 64/25; B33Y 30/00; B29C 64/209

(57) ABSTRACT

A frameless three-dimensional (3D) printing system for printing 3D objects includes a mounting plate structure, a 3D-printing module, and at least one mounting assembly. The mounting plate structure includes front and back sides and defines a periphery thereof. The mounting plate structure is aligned in one of a vertical orientation, a horizontal orientation or an inclined orientation. Further, the 3D-printing module is mounted on the front side surface of the mounting plate structure to be aligned in one of the vertical orientation, the horizontal orientation or the inclined orientation along with the mounting plate structure. The at least one mounting assembly is configured on the back side surface of the mounting plate structure to enable the mounting plate structure and the 3D-printing module to align in one of the vertical orientation, the horizontal orientation or the inclined orientation.

### FIELD OF THE DISCLOSURE

The present disclosure relates to field of 3D-printing technology, and, more particularly, to a frameless 3D-printer.

### BACKGROUND OF THE DISCLOSURE

Three-Dimensional (3D) printing is a process of manufacturing objects by adding various layers of one or other materials through a 3D-printer to obtain a 3D-structure based on a 3D-model. Now a days, 3D-printing involves a lot of influence from science and technology and is why this is field of constant innovation. Specifically, in the process of 3D-printing, a user usually requires a virtual 3D-model of an object, one or more material for obtaining the 3D-structure based on the 3D-model of the object, and a 3D-printer to spray the material to obtain the 3D-structure. More often than not, the user requires a 3D-printer, which may exhibit characteristics like easy portability, installation, operability, and so forth.

The 3D-printing system is generally used in various locations and may also require to be transported for use. There are several conventional 3D-printing systems available today, which are installed at certain locations or place and capable to print the objects.

Conventional 3D-printer systems may be effective in meeting various requirements but may not be able to address some of the specific problems. For example, the conventional 3D-printing systems may require lots of floor space or work bench space for installation. Also, the conventional 3D-printing systems require lots of manpower and equipment for its transportation from one place to another. As a result, the conventional 3D-printing system may not be transported in short time. Further, the conventional 3D-printing systems consist of body frame which limits the user's visibility to the tool head during operation. Thus, such conventional 3D-printing systems are found to be ineffective in installation, transportation and ineffective in providing the visibility to the tool head working.

The conventional ones may be a rectangular or an inverted T-shaped 3D-printing systems, where 3D-printing system mount to more than one side of the 3D printer frame, thereby making the system bulky and requiring ample space to operate.

Accordingly, there is a need to overcome various existing problems related to the conventional 3D-printing systems. For example, there is a need for a 3D-printing system that may be capable of being installed over very less or no floor space or work bench space. Further, there is a need of such 3D-printing system that may be transported from one place to another in very short period of time. Furthermore, there is a need of such 3D-printing system that may provide good visibility to the tool head during operation.

### SUMMARY OF THE DISCLOSURE

In view of the foregoing disadvantages inherent in the prior art, the general purpose of the present disclosure is to provide a frameless 3D-printer and system, to include all advantages of the prior art, and to overcome the drawbacks inherent in the prior art.

In light of the above problem, an object of the present disclosure is to provide a 3D-printing system and/or method to overcome various existing problems related to the conventional 3D-printing systems. For example, an object of the present disclosure is to provide a 3D-printing system and/or method that may be capable of being installed over very less or no floor space or work bench space. Further, another object of the present disclosure is to provide a 3D-printing system and/or method that may be transported from one place to another in very short period of time.

Further, additional objects of the present disclosure are to provide a 3D-printing system/method that may provide good visibility to the tool head during operation. In this manner, 3D-printing will be compact, more portable and operable.

Furthermore, an object of the present disclosure is to provide a 3D-printing system/method that may be scalable to any desired size.

In view of the above objects, in one aspect of the present disclosure, a frameless three-dimensional (3D) printing system for printing 3D objects is provided. The frameless 3D printing system may include a mounting plate structure, a 3D-printing module, and at least one mounting assembly. The mounting plate structure may include a front side surface, and a back side surface opposite to the front side surface. The mounting plate structure defining a periphery thereof. The mounting plate structure may be configured to be aligned in one of a vertical orientation, a horizontal orientation or an inclined orientation. Further, the 3D-printing module may be mounted on the front side surface of the mounting plate structure to be aligned in one of the vertical orientation, the horizontal orientation, or the inclined orientation along with the mounting plate structure. The at least one mounting assembly may be configured on the back side surface of the mounting plate structure to enable the mounting plate structure and the 3D-printing module to align in one of the vertical orientation, the horizontal orientation, or the inclined orientation.

In one embodiment of the present disclosure, the 3D-printing module includes a plurality of components operatively coupled to each other and mounted on the mounting plate structure such that the plurality of components is accommodated substantially within the periphery of the mounting plate structure to perform 3D-printing. The plurality of components may include one or more of a printing bed assembly, an extruder arrangement, a filament feed tube member, and a motion control arrangement. In one embodiment, the printing bed assembly may or may not be included in the 3D-printing module. The plurality of components may further include a plurality of locking assembly associated with the plurality of components to lock and unlock movements of the plurality of components during transportation and while using the frameless 3D-printing system. In one example arrangement, the plurality of locking assembly may include: a spool locking assembly associated with the filament feed tube member, an extruder locking assembly associated with the extruder arrangement, and a printing bed locking assembly associated with the printing bed assembly. All these components are mounted on a single mounting plate structure.

Such an arrangement of the plurality of components, which are redesigned in such a manner that all such components are incorporated on one single plate.

In one embodiment, the frameless 3D-printing system further may be secured to a casing, transportable cart or a wall to operation thereof.

The afore-mentioned objectives and additional aspects of the embodiments herein will be better understood when read in conjunction with the following description and accompanying drawings. It should be understood, however, that the following descriptions, while indicating preferred embodiments and numerous specific details thereof, are given by way of illustration and not of limitation. This section is intended only to introduce certain objects and aspects of the present disclosure, and is therefore, not intended to define key features or scope of the subject matter of the present disclosure.

### BRIEF DESCRIPTION OF THE DRAWINGS

The figures mentioned in this section are intended to disclose exemplary embodiments of the claimed system and method. Further, the components/modules and steps of a process are assigned reference numerals that are used throughout the description to indicate the respective components and steps. Other objects, features, and advantages of the present disclosure will be apparent from the following description when read with reference to the accompanying drawings.

FIG. 1A illustrates a front view of a frameless 3D-printing system, in accordance with an exemplary embodiment of the present disclosure;

FIG. 1B illustrates a perspective view of a portion of the frameless 3D-printing system of FIG. 1A to depict at least one mounting assembly, in accordance with an exemplary embodiment of the present disclosure;

FIG. 2 illustrates a perspective view of a portion of the frameless 3D-printing system of FIG. 1A to a depict a filament feed tube member with a spool locking assembly, in accordance with an exemplary embodiment of the present disclosure;

FIG. 3 illustrates a perspective view of a portion of the frameless 3D-printing system of FIG. 1A to depict an extruder arrangement, in accordance with various exemplary embodiments of the present disclosure; and

FIGS. 4A and 4B, illustrate perspective views of a portion of the frameless 3D-printing system of FIG. 1A to, respectively, depict an extruder locking assembly an unlocked state of the extruder arrangement, and in a locked state of the extruder arrangement, in accordance with an exemplary embodiment of the present disclosure;

FIG. 5 illustrates a perspective view of a portion of the frameless 3D-printing system of FIG. 1A to depict a printing bed assembly, in accordance with an exemplary embodiment of the present disclosure;

FIGS. 6A and 6B, illustrate perspective views of a portion of the frameless 3D-printing system of FIG. 1A to, respectively, depict a printing bed locking assembly in an unlocked state of the printing bed assembly, and in a locked state of the printing bed assembly, in accordance with an exemplary embodiment of the present disclosure;

FIGS. 7A and 7B, illustrate, respectively a casing and a portion of the casing incorporating the frameless 3D-printing system of FIG. 1A, in accordance with an exemplary embodiment of the present disclosure;

FIG. 8 illustrates a transportation cart incorporating the frameless 3D-printing system of FIG. 1A, in accordance with an exemplary embodiment of the present disclosure; and

FIG. 9 illustrates the frameless 3D-printing system of FIG. 1A mounted on a wall, in accordance with an exemplary embodiment of the present disclosure.

Like reference numerals refer to like parts throughout the description of several views of the drawing.

### DETAILED DESCRIPTION OF THE DISCLOSURE

This section is intended to provide explanation and description of various possible embodiments of the present disclosure. The embodiments used herein, and various features and advantageous details thereof are explained more fully with reference to non-limiting embodiments illustrated in the accompanying drawings and detailed in the following description. The examples used herein are intended only to facilitate an understanding of ways in which the embodiments herein may be practiced and to further enable the person skilled in the art to practice the embodiments used herein. Also, the examples/embodiments described herein should not be construed as limiting the scope of the embodiments herein. Corresponding reference numerals indicate corresponding parts throughout the drawings.

The terms “a” and “an” herein do not denote a limitation of quantity, but rather denote the presence of at least one of the referenced items.

The terms “having”, “comprising”, “including”, and variations thereof signify the presence of a component.

In view of the above objects, in one aspect of the present disclosure, a frameless three-dimensional (3D) printing system for printing 3D objects is provided. The frameless 3D printing system may include a mounting plate structure, a 3D-printing module, and at least one mounting assembly. The mounting plate structure may include a front side surface, and a back side surface opposite to the front side surface. The mounting plate structure defining a periphery thereof. The mounting plate structure may be configured to be aligned in one of a vertical orientation, a horizontal orientation or an inclined orientation. Further, the 3D-printing module may be mounted on the front side surface of the mounting plate structure to be aligned in one of the vertical orientation, the horizontal orientation or the inclined orientation along with the mounting plate structure. The at least one mounting assembly may be configured on the back side surface of the mounting plate structure to enable the mounting plate structure and the 3D-printing module to align in one of the vertical orientation, the horizontal orientation or the inclined orientation.

In one embodiment of the present disclosure, the 3D-printing module includes a plurality of components operatively coupled to each other and mounted on the mounting plate structure such that the plurality of components is accommodated substantially within the periphery of the mounting plate structure to perform 3D-printing. The plurality of components may include one or more of a printing bed assembly, an extruder arrangement, a filament feed tube member, and a motion control arrangement. In one embodiment, the printing bed assembly may or may not be included in the 3D-printing module. The plurality of components may further include a plurality of locking assembly associated with the plurality of components to lock and unlock movements of the plurality of components during transportation and while using the frameless 3D-printing system. In one example arrangement, the plurality of locking assembly may include: a spool locking assembly associated with the filament feed tube member, an extruder locking assembly associated with the extruder arrangement, and a printing bed locking assembly associated with the printing bed assembly. All these components are mounted on a single mounting plate structure.

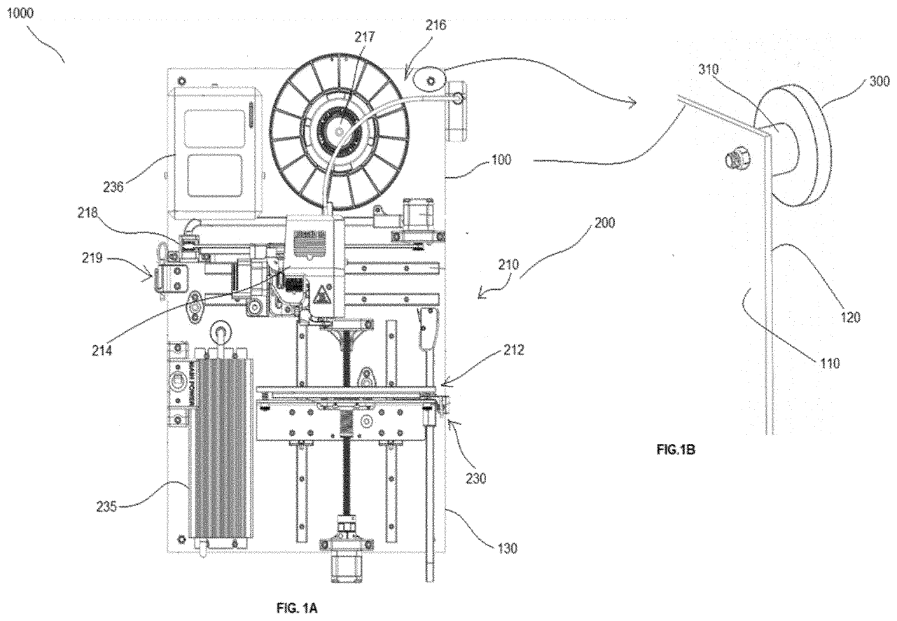

Referring now FIGS. 1A and 1B, which, respectively, illustrates a front view of a frameless 3D-printing system 1000, and a perspective view of a portion of the frameless 3D-printing system 1000 of FIG. 1A, in accordance with an exemplary embodiment of the present disclosure. As depicted in FIGS. 1A and 1B, a frameless 3D printing system 1000 for printing 3D objects is provided. The frameless 3D printing system 1000 may include a mounting plate structure 100, a 3D-printing module 200, and at least one mounting assembly 300. The mounting plate structure 100 may include a front side surface 110, and a back side surface 120 opposite to the front side surface 110. The mounting plate structure 100 defining a periphery 130 thereof. The mounting plate structure 100 may be configured to be aligned in one of a vertical orientation, a horizontal orientation or an inclined orientation. Further, the 3D-printing module 200 may be mounted on the front side surface 110 of the mounting plate structure 100 to be aligned in one of the vertical orientation, the horizontal orientation or the inclined orientation along with the mounting plate structure 100. The at least one mounting assembly 300 may be configured on the back side surface 120 of the mounting plate structure 100 to enable the mounting plate structure 100 and the 3D-printing module 200 to align in one of the vertical orientation, the horizontal orientation or the inclined orientation.

As depicted in FIGS. 1A and 1B, in one embodiment of the present disclosure, the mounting plate structure 100 may be a single piece structure of one of metals, plastics, composites or woods or any other suitable material. In one another embodiment, the mounting plate structure 100 may include multiple plates coupled to form a single piece structure, such as the mounting plate structure 100. In such embodiment, the multiple plates may also be made of one of metal, steel, plastic, composites or wood or any other suitable material.

Further, as depicted in FIGS. 1A and 1B, in one embodiment of the present disclosure, the 3D-printing module 200 includes a plurality of components 210 operatively coupled to each other and mounted on the mounting plate structure 100 such that the plurality of components 210 is accommodated substantially within the periphery 130 of the mounting plate structure 100 to perform 3D-printing. The plurality of components 210 may include one or more of a printing bed assembly 212, an extruder arrangement 214, a filament feed tube member 216, and a motion control arrangement 218. In one embodiment, the printing bed assembly 212 may or may not be included in the 3D-printing module 200. Further, the plurality of components 210 may include a plurality of locking assembly, such as locking assemblies 217, 219 and 230 associated with the plurality of components 210 to lock and unlock movements of the plurality of components 210 during transportation and while using the frameless 3D-printing system 1000. In one example arrangement, the plurality of locking assembly may include: a spool locking assembly 217 associated with the filament feed tube member 216, an extruder locking assembly 219 associated with the extruder arrangement 214, and a printing bed locking assembly 230 associated with the printing bed assembly 212. These locking assemblies 217, 219 and 230 may be incorporated on the mounting plate structure 100 and be operated upon the requirement. The locking assemblies 217, 219 and 230 as depicted herein are according to one example and that various other types of locking member may be incorporated for the said purpose and operation of the frameless 3D-printing system 1000.

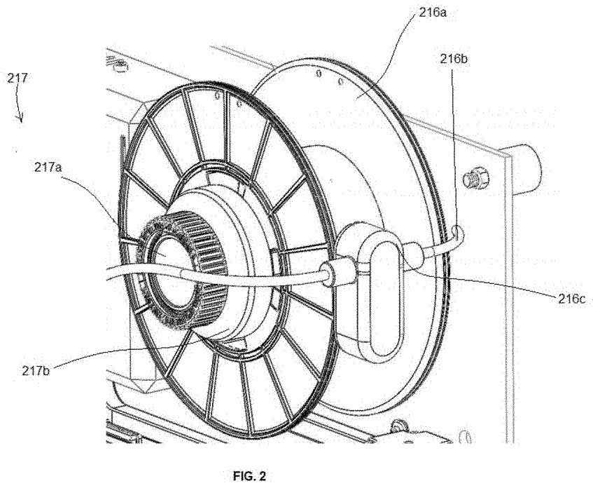

The frameless 3D printing system 1000 including the mounting plate structure 100, the 3D-printing module 200, and at least one mounting assembly 300 with the respective locking assemblies 217, 219 and 230 will be described in detail with respect to FIGS. 2 to 6B herein, in conjunction with FIGS. 1A and 1B.

Referring now to FIG. 2, which illustrates a perspective view of a portion of the frameless 3D-printing system 1000 of FIG. 1A to depict the filament feed tube member 216 with the spool locking assembly 217, in accordance with an exemplary embodiment of the present disclosure. As depicted, in one embodiment of the present disclosure, the filament feed tube member 216 may be mounted on the mounting plate structure 100 to feed raw materials (not shown) to the extruder arrangement 214. In one of the exemplary embodiments, the filament feed tube member 216 may include a spool member 216a, a raw material feed tube 216b, and a smart sensor member 216c. The spool member 216a is operatively coupled to the mounting plate structure 100 to receive the raw materials. The raw material feed tube 216b may be operatively coupled to spool member 216a to feed the raw material to the extruder arrangement 214. The smart sensor member 216c may be coupled to the raw material feed tube 216b to sense overfeed of the raw material in the extruder arrangement 214 and calibrate the raw material feed tube 216b and the 3D-printing module 200. For doing so, the smart sensor member 216c may include a calibrating module with processors, which upon the requirement may calibrate the raw material feed tube 216b and the 3D-printing module 200, when the smart sensor member 216c senses overfeed of the raw material in the extruder arrangement 214. In one of various embodiment, the smart sensor member 216c may detect errors in 3D printing using basic and or predictive logic. The smart sensor member 216c is capable of automatically pause the 3D-printing module 200 to enable a user to perform repairs. The smart sensor member 216c may also collect performance metrics on the 3D-printing module 200 to create machine operational metrics and build artificial intelligence to improve the performance of the 3D-printing module 200. The smart sensor member 216c may be an electromechanical sensor that collects data on the raw material as it passes through its internal sensors. One or additional sensors may be installed in the 3D printer to detect errors and improve the 3D-printing module 200.

Further, depicted in FIG. 2, in one embodiment of the present disclosure, the spool locking assembly 217 is configured to lock and unlock a movement of the spool member 216a, upon requirement, such as while transporting the 3D-printing system 100. In one such exemplary embodiment, the spool locking assembly 217 may include a spool mount 217a and a mounting nut 217b. The spool mount 217a may be coupled to the mounting plate structure 100 to rotatably receives the spool member 216a. The mounting nut 217b may be operatively coupled to the spool mount 217a to lock and unlock a rotation of the spool member 216a. For example, during the transportation of the 3D-printing system 100, the spool mount 217a may be pressed to lock the movement of the spool member 216a, and for using after transportation, the spool mount 217a may be again pressed to unlock the movement of the spool member 216a.

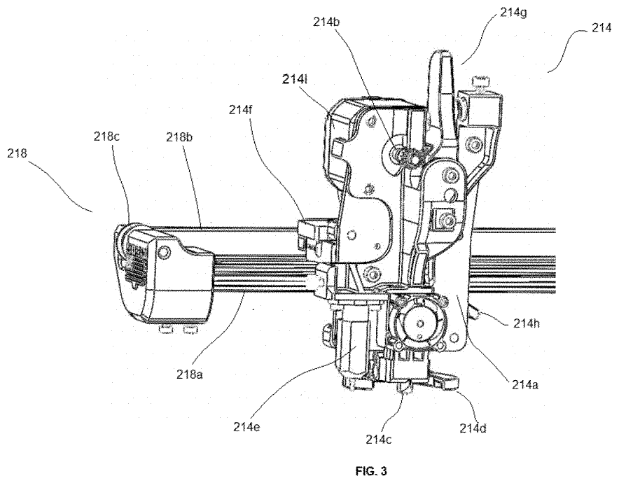

Referring now to FIG. 3, which illustrates a perspective view of a portion of the frameless 3D-printing system 1000 of FIG. 1A to depict the extruder arrangement 214, and will be described in conjunction with FIGS. 1A to 2, in accordance with various exemplary embodiments of the present disclosure. In one embodiment of the present disclosure, the extruder arrangement 214 may be movably and detachably mounted on the mounting plate structure 100. Further, the motion control arrangement 218 may be mounted on the mounting plate structure 100 to move, adjust and control movement of the extruder arrangement 214. The motion control arrangement 218 comprises a rail assembly 218a and a belt-pully arrangement 218b to enable the movement of the extruder arrangement 214 across the mounting plate structure 100.

As depicted in FIG. 3, in one embodiment of the present disclosure, the extruder arrangement 214 may include various elements to perform the operation. The extruder arrangement 214 may, for example, include an extruder plate 214a, an extruder gear 214b, a nozzle assembly 214c, a cooling duct 214d, a smart levelling sensor 214e, a carriage 214f, and tensioner 214g and release 214h arms. The extruder gear 214b may be coupled to the extruder plate 214a. The extruder gear 214b may receive the raw materials from the filament feed tube member 216 and push down further for operation. The nozzle assembly 214c is coupled to the extruder gear 214b to receive the raw material pushed down by the extruder gear 214b to extrude to make the 3D objects. The cooling duct 214d is coupled on the extruder plate 214a proximate to the nozzle assembly 214c to pneumatically cool the nozzle assembly 214c. However, without departing from the scope of the present disclosure, cooling may be achieved by circulating fluid by utilizing suitable hydraulic cooling arrangement.

Further, as seen in FIG. 3, the smart levelling sensor 214e may be coupled on the extruder plate 214a proximate to the cooling duct 214d to constantly measure and align distance of the nozzle assembly 214c from the 3D printing objects.

Furthermore, the carriage 214f is coupled to the extruder plate 214a and engage with the motion control arrangement 218 to enable the movement of the extruder arrangement 214 across the mounting plate structure 100 or across any other surface, where the 3D-printing system may not include the mounting plate structure 100. Further, the tensioner 214g and release 214h arms are operatively coupled to the extruder plate 214a to control the movement of the extruder arrangement 214 across the mounting plate structure 100. Further, a suitable motor, such as a motor 214i may be provided on the mounting plate structure 100 run the extruder arrangement 214.

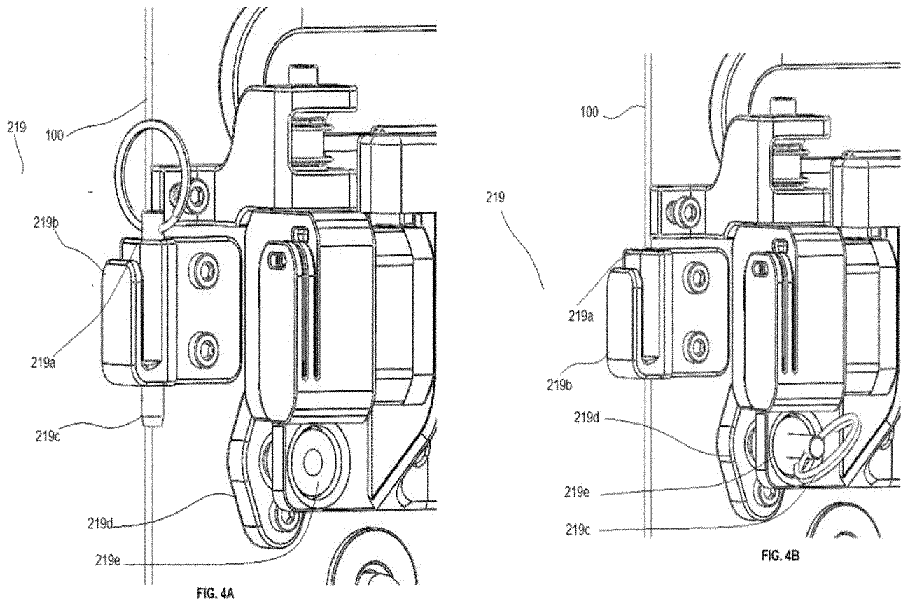

Referring now to FIGS. 4A and 4B, which illustrate perspective views of a portion of the frameless 3D-printing system 1000 of FIG. 1A to, respectively, depict the extruder locking assembly 219 in an unlocked state of the extruder arrangement 214, and in a locked state of the extruder arrangement 214, in accordance with an exemplary embodiment of the present disclosure.

As depicted, in one embodiment of the present disclosure, the extruder locking assembly 219 may be configured to lock and unlock a movement of the extruder arrangement 214. In one example arrangement, the extruder locking assembly 230 may include an extruder pin recess 219a, an extruder lock pin member 219c, a first extruder pin lock receiver 219d, and a second extruder pin lock receiver 219e. The extruder pin recess 219a may be formed in a coupling assembly 219b coupled to the mounting plate structure 100. The extruder lock pin member 219c is normally received in the extruder pin recess 219a (as seen in FIG. 4A) in the unlocked state to unlock the movement of the extruder arrangement 214. Further, the first extruder pin lock receiver 219d is formed on the mounting plate structure 100, and the second extruder pin lock receiver 219e is formed along the extruder arrangement 214. The first and second extruder pin lock receivers 219d, 219e may be aligned to receive the extruder lock pin member 219c in the locked state (as seen in FIG. 4B) to lock the movement of the extruder arrangement 214, while transporting the 3D-printing system 1000. For example, during the transportation of the 3D-printing system 100, the extruder lock pin member 219c may be taken out from the coupling assembly 219b and be inserted in the aligned first extruder pin lock receiver 219d and the second extruder pin lock receiver 219e to lock the movement of the extruder arrangement 214, and for using after transportation, the extruder lock pin member 219c may be taken out from the aligned first extruder pin lock receiver 219d and the second extruder pin lock receiver 219e to unlock the movement of the extruder arrangement 214.

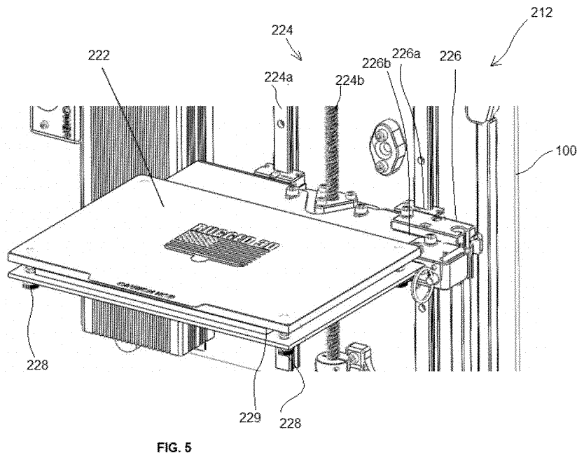

Referring now to FIG. 5, which illustrates a perspective view of a portion of the frameless 3D-printing system 1000 of FIG. 1A to depict the printing bed assembly 212 and will be described in conjunction with FIGS. 1A to 4B, in accordance with various exemplary embodiments of the present disclosure.

As seen, in one embodiment of the present disclosure, the printing bed assembly 212 may include a printing bed 222, an adjusting and moving assembly 224, and a coupling assembly 226. The printing bed 222 may be removably and adjustable coupled to and perpendicularly extends from the mounting plate structure 100 below the extruder arrangement 214. The adjusting and moving assembly 224 may be coupled to the mounting plate structure 100 to vertically adjust and move the printing bed 212 on the mounting pate structure 100. The adjusting and moving assembly 224 may include a rail assembly 224a and an adjusting member 224b. The adjusting member 224b is threadably received along the printing bed 222 to vertically adjust the printing bed 222 on the rail assembly 224a. Further, the coupling assembly 226 may include a first receiving slot 226a and a second receiving slot 226b. The first receiving slot 226a removably and movably receives the rail assembly 224a of the adjusting and moving assembly 224, and the second receiving slot 226b removably receives the printing bed 222 to removably couple the printing bed 222 to the mounting plate structure 100.

Further, in one embodiment of the present disclosure, the printing bed assembly 212 further includes a level adjusting member 228 and a heating module 229. The level adjusting member 228 may be coupled underneath of the printing bed 222 to adjust the level or angle of the printing bed 222. The level adjusting member 228 may include one of a screw-nut assembly, a lever assembly, an electromagnetic assembly for adjusting the level or angle of the printing bed 222. Further, the heating module 229 may be coupled to the printing bed 222 to heat the printing bed 222 as and when required which operation of the 3D-printing module 1000.

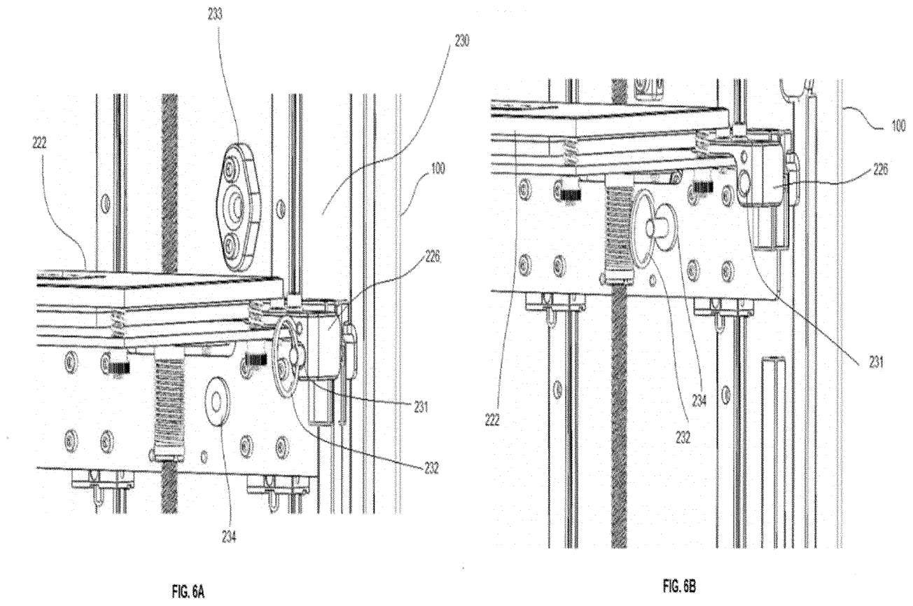

Referring now to FIGS. 6A and 6B, which illustrate perspective views of a portion of the frameless 3D-printing system 1000 of FIG. 1A to, respectively, depict the printing bed locking assembly 230 in an unlocked state of the printing bed assembly 212, and in a locked state of the printing bed assembly 212, in accordance with an exemplary embodiment of the present disclosure.

As depicted, in one embodiment of the present disclosure, the printing bed locking assembly 230 is configured to lock and unlock a movement of the printing bed 222. The printing bed locking assembly 230 may include various associated elements, such as a pin recess 231, a pin lock member 232, a first pin lock receiver 233, and a second pin lock receiver 234. The pin recess 231 may be formed in the coupling assembly 226. Further, the pin lock member 232 may be configured to be received in the pin recess 231 (as seen in FIG. 6A) to unlock the movement of the printing bed 222. Further, the first pin lock receiver 233 may be formed on the mounting plate structure 100, and the second pin lock receiver 234 may be formed along the printing bed 222. The first and second pin lock receivers 233, 234 are aligned to receive the pin lock member 232 (as seen in FIG. 6B) to lock the movement of the printing bed 222 while transporting the 3D-printing system 100. For example, during the transportation of the 3D-printing system 1000, the pin lock member 232 may be taken out from the pin recess 231 and be inserted in the aligned first and second pin lock receivers 233, 234 to lock the movement of the printing bed 222, and for using after transportation, the pin lock member 232 may be taken out from the aligned first and second pin lock receivers 233, 234 to unlock the movement of the extruder arrangement 214.

Further, referring back to FIG. 1, in one embodiment, the frameless 3D-printing system 1000 may also include a power source with a switch 235 and a control panel 236 mounted on the mounting plate structure to power and control the plurality of components 210 of the 3D-printing module 200.

Further, referring to FIG. 1, the at least one mounting assembly 300 as configured on the back side surface 120 of the mounting plate structure 100 may be one of a magnetic mounting assembly, or a mounting assembly in the form of clips and hangers. In one further arrangement, as seen in FIG. 1B, the frameless 3D-printing system 1000 may further include a vibration damping members 310 coupled along the back side surface 120 of the mounting plate structure 100 along corners thereof to reduce vibration of the mounting plate structure 100. the at least one mounting assembly 300 and the vibration damping members 310 are effective in coupling the mounting plate structure 100 to a casing, such as a casing 400, or a transportable cart, such as a transportable cart 500, or to a wall 600, for printing the 3D-objects, and will described herein below.

The at least one mounting assembly 300 as illustrated include four magnetic mounts, one on each corner of the mounting plate structure 100. The magnets may attach, the frameless 3D-printing system 1000 to any ferrous surface in any orientation. Further, non-ferrous surfaces will use ferrous mounting pads to enable the magnetic connection. The orientation of the magnets can be reconfigured to enable, the frameless 3D-printing system 1000 to be mounted on poles, bars, crates, shelving, and other complex shapes. Further, the vibration damper may be a spring, rubber, pneumatic, electromagnetic, or a hook and clasp system. The frameless 3D-printing system 1000 keeps most of its mass on the main plate which makes it favorable for wall mounting.

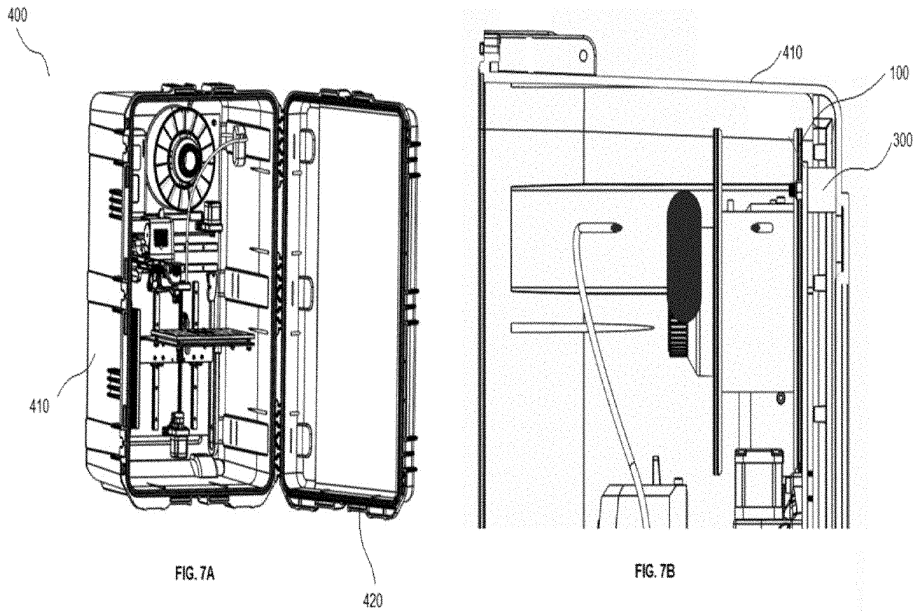

Referring now to FIGS. 7A and 7B, the frameless 3D-printing system 1000 further includes the casing 400. The casing 400 includes a receiving compartment 410 and a covering element 420. The receiving compartment 410 is configured to receive the mounting plate structure 100 to be coupled via the mounting assembly 130 along with the damping member 310 in such a manner that the 3D-printing module 200 is accommodated within the receiving compartment 410 and that the vibration is prevented. Further, the covering element 420 is coupled to the receiving compartment 410 to cover the receiving compartment 420.

The casing 400 shown may be capable of providing mounting support to the frameless 3D-printing system 1000. The frameless 3D-printing system 1000 installed inside the casing 400 makes the frameless 3D-printing system 1000 more robust, durable and portable. The casing 400 encapsulating the frameless 3D-printing system 1000 also provides safety to each and every part of the frameless 3D-printing system 1000 upon experiencing shocks. Such an arrangement protects the entire 3D-printing system 1000 from impacts experienced during portability, installation, operability, and so forth. In one embodiment, the casing 400 may be a rigid and firm structure made of thick metals using brackets and frames which makes the frameless 3D-printing system 1000 safe for the transportation in harsh geographical landscapes.

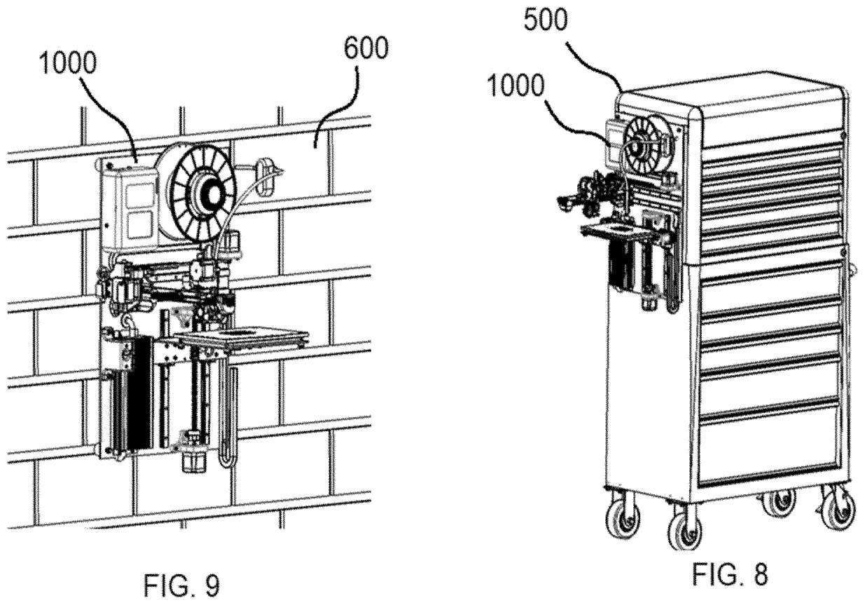

Referring now FIG. 8, a transportation cart 500 incorporating the frameless 3D-printing system 1000 of FIG. 1A is illustrated, in accordance with an exemplary embodiment of the present disclosure. As shown, the frameless 3D-printing system 1000 may include the transportation cart 500, wherein the mounting plate structure 100 is coupled via the mounting assembly 130 over the transportation cart 500 in such a manner that the 3D-printing module 200 is aligned vertically, horizontally, or inclinedly on the transportation cart 500. The coupling of the frameless 3D-printing system 1000 with the transportable cart 5000 may make the frameless 3D-printing system 1000 more portable and user friendly as compared to the conventional 3D-printing module. The frameless 3D-printing system 1000 may be easily transported from one place to another in a very short duration of time. Also, such frameless 3D-printing system 1000 may facilitate 3D-printing on any place of a user's choice.

Referring now FIG. 9, the frameless 3D-printing system 1000 of FIG. 1A may be mounted on a wall 600, wherein the mounting plate structure 100 is coupled via the mounting assembly 130 over the wall 600 in such a manner that the 3D-printing module 200 is aligned vertically, horizontally, or inclinedly on the wall 600. In one embodiment, the wall 600 may be vertical, horizontally, or inclined wall.

The frameless 3D-printing system 1000 may be oriented in any direction, such as upside down, sideways, flat on a surface, or at inclined orientation. In the one embodiment of the disclosure, the frameless 3D-printing system may be a modular and scalable to any size. In the one embodiment of the present disclosure, when the frameless 3D-printing system are installed on the vertical space, such as the wall, such mounting plate structure 100 of the frameless 3D-printing system does not twist due to its rigidity and strength. When the frameless 3D-printing system are installed on the vertical space, such as the wall, the frameless 3D-printing system put most of its mass close to the wall, which provides a favorable weight distribution for the wall mounting. The frameless 3D-printing system keeps all the 3D-printing components on one side of the plate, which removes the risk of interference on the wall. Further, the mounting of the 3D-printing system brings lots of advantage when compared to the conventional 3D-printing system, for example, rectangular or inverted T-shaped 3D-printing systems. The feature of mounting the 3D-printing system on the wall makes the 3D-printing system of the present disclosure capable of working without using any floor space or work bench space. Thus, the frameless 3D-printing system mounted on the wall saves lots of floor and work bench space in the workshop.

Advantageously, the 3D-printing module may be frameless and has an L-shaped structure. The L-shaped structure may be due to coupling orientation of the at least one mounting plate and the at least one printing bed with respect to each other. In such example embodiment, the at least one printing bed may be coupled perpendicularly to the at least one mounting plate. All the other parts or elements, such as the at least one filament feed tube member, the at least one extruder arrangement and the at least one motion control arrangement, and the plurality of associated components of the frameless 3D-printing module may be coupled together and placed over various locations as per the location of the printing bed on the mounting plate.

Advantageously, such an assembly of the 3D-printing system enables all 3D-printing to occur on only one side of the at least one mounting plate, unlike conventional rectangular or inverted T-shaped 3D-printing systems, where 3D-printing occurs on from more than one sides, thereby making such conventional T-shaped 3D-printing cumbersome to use. With such an assembly of the 3D-printing system, the present disclosure enables easy 3D-printing.

Advantageously, such an assembly of the 3D-printing system of the present disclosure provides clear visibility to the user to observe the tool head while operation. Particularly, such an assembly of the 3D-printing system, where all the components or its associated parts are provided on one single plate, i.e., on the mounting plate, enable to obtain a frameless structure of the 3D-printing system. Dues to such frameless structure of the 3D-printing system clear visibility to the user to observe the tool head while operation is inevitable.

Advantageously, the extruder arrangement as described above may draw the raw materials (printing material) therefrom through the motor and pushes the raw materials forward, where the raw materials melts and further sprayed out for printing on the printing bed. The printing bed is a surface over which printing is done. The printing bed facilitates sticking of the filament over itself and once printing is done it further facilitates removal of printed object from its own surface. There are different kinds of printing bed and one can choose the type of printing bed based on his/her requirement. The printing over the printing bed is done according to the model of the object which is to be printed.

In one other embodiment of the present disclosure, the frameless assembly of the present invention may be adapted to various other product manufacturing design or process. There is also conventional Computerized Numerical Control (CNC) machine with frames that are cumbersome to use. Also, there is need of providing a frameless CNC machine and the present set-up may be easily adapted to the CNC machines to make frameless CNC machine system. For example, such frameless CNC machine may be adapted on a single mountable plate. Such Frameless CNC machine may include a single plate having two opposite sides, i.e., a front side and a back side. On the front side of the single plate, various parts or associated components of the CNC machine redesigned and mounted such that all parts or associated components of such CNC machines may lie on that single plate. Further, on the back side of the single plate any suitable mounting assembly may be provided that may enable the mounting of the frameless CNC machine on any vertical surface, such as walls, or any horizontal surface, such as shop floors. In one embodiment, without departing from the scope of the present disclosure, mounting assembly may be one of magnetic mounting assembly, or mounting assembly in the form of clips, hangers, or any other similar types of wall mounting solutions.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

What is claimed is:

1. A frameless three-dimensional (3D) printing system for printing 3D objects, the frameless 3D printing system comprising:
a mounting plate structure having a front side surface, and a back side surface opposite to the front side surface, the mounting plate structure defining a periphery, the mounting plate structure configured to be aligned in one of a vertical orientation, a horizontal orientation, or an inclined orientation;
a 3D-printing module mounted on the front side surface of the mounting plate structure to be aligned in one of the vertical orientation, the horizontal orientation or the inclined orientation along with the mounting plate structure; and
at least one mounting assembly configured on the back side surface of the mounting plate structure to enable the mounting plate structure and the 3D-printing module to align in one of the vertical orientation, the horizontal orientation, or the inclined orientation.

2. The frameless 3D-printing system of claim 1, wherein the mounting plate structure is a single piece structure of one of metals, plastics, composites or woods.

3. The frameless 3D-printing system of claim 1, wherein the mounting plate structure comprises multiple plates coupled to form a single piece structure, wherein the multiple plates are made of one of metal, steel, plastic, composites or wood.

4. The frameless 3D-printing system of claim 1, wherein the 3D-printing module comprises:
a plurality of components operatively coupled to each other and mounted on the mounting plate structure such that the plurality of components is accommodated substantially within the periphery of the mounting plate structure to perform 3D-printing, wherein the plurality of components comprises one or more of a filament feed tube member, an extruder arrangement, a motion control arrangement, or a printing bed assembly; and
a plurality of locking assembly associated with the plurality of components to lock and unlock movements of the plurality of components during transportation and while using the frameless 3D-printing system, wherein the plurality of locking assembly comprises:
a spool locking assembly associated with the filament feed tube member, an extruder locking assembly associated with the extruder arrangement, or a printing bed locking assembly associated with the printing bed assembly.

5. The frameless 3D-printing system of claim 5, wherein the filament feed tube member mounted on the mounting plate structure to feed raw materials to the extruder arrangement, wherein the filament feed tube member comprises:
a spool member operatively coupled to the mounting plate structure to receive raw materials;
a raw material feed tube operatively coupled to spool member to feed the raw material to the extruder arrangement; and
a smart sensor member coupled to the raw material feed tube to sense overfeed of the raw material in the extruder arrangement and calibrate the raw material feed tube and the 3D-printing module.

6. The frameless 3D-printing system of claim 5, wherein the spool locking assembly is configured to lock and unlock a movement of the spool member, the spool locking assembly having:
a spool mount coupled to the mounting plate structure to rotatably receives the spool member; and
a mounting nut operatively coupled to the spool mount to lock and unlock a rotation of the spool member.

7. The frameless 3D-printing system of claim 4, wherein the extruder arrangement is movably and detachably mounted on the mounting plate structure; and
the motion control arrangement mounted on the mounting plate structure to move, adjust and control movement of the extruder arrangement, wherein the motion control arrangement comprises a rail assembly and a belt-pully arrangement to enable the movement of the extruder arrangement across the mounting plate structure.

8. The frameless 3D-printing system of claim 7, wherein the extruder arrangement comprises:
an extruder plate;
an extruder gear coupled to the extruder plate, wherein the extruder gear receives raw materials from the filament feed tube member and push down;
a nozzle assembly coupled to the extruder gear to receive the raw material pushed down by the extruder gear to extrude to make the 3D objects;
a cooling duct coupled on the extruder plate proximate to the nozzle assembly to pneumatically cool the nozzle assembly;
a smart levelling sensor coupled on the extruder plate proximate to the cooling duct to constantly measure and align distance of the nozzle assembly from the 3D printing objects,
a carriage coupled to the extruder plate and engaged with the motion control arrangement to enable the movement of the extruder arrangement across the mounting plate structure; and
tensioner and release arms operatively coupled to the extruder plate to control the movement of the extruder arrangement across the mounting plate structure.

9. The frameless 3D-printing system of claim 8, wherein the extruder locking assembly configured to lock and unlock a movement of the extruder arrangement, the extruder locking assembly having:
an extruder pin recess formed in the coupling assembly coupled to the mounting plate structure;
an extruder lock pin member to be received in the extruder pin recess to unlock the movement of the extruder arrangement;
a first extruder pin lock receiver formed on the mounting plate structure; and
a second extruder pin lock receiver formed along the extruder arrangement, wherein the first and second extruder pin lock receivers are aligned to receive the extruder lock pin member to lock the movement of the extruder arrangement.

10. The frameless 3D-printing system of claim 4, wherein the printing bed assembly comprises:
a printing bed removably and adjustable coupled to and perpendicularly extends from the mounting plate structure below the extruder arrangement;
an adjusting and moving assembly coupled to the mounting plate structure to vertically adjust and move the printing bed on the mounting pate structure, the adjusting and moving assembly having a rail assembly and adjusting member, wherein the adjusting member threadably received along the printing bed to vertically adjust the printing bed;
a coupling assembly having a first receiving slot and a second receiving slot, wherein the first receiving slot removably and movably receives the rail assembly of the adjusting and moving assembly, and wherein the second receiving slot removably receives the printing bed to removably couple the printing bed to the mounting plate structure.

11. The frameless 3D-printing system of claim 10, wherein the printing bed assembly further comprises:
at least one level adjusting member coupled underneath of the printing bed to adjust the level or angle of the printing bed, wherein the at least one level adjusting member comprises one of a screw-nut assembly, a lever assembly, an electromagnetic assembly; and
a heating module coupled to the printing bed to heat the printing bed as and when required.

12. The frameless 3D-printing system of claim 11, wherein the printing bed locking assembly configured to lock and unlock a movement of the printing bed, the printing bed locking assembly having:
a pin recess formed in the coupling assembly;
a pin lock member to be received in the pin recess to unlock the movement of the printing bed;
a first pin lock receiver formed on the mounting plate structure; and
a second pin lock receiver formed along the printing bed, wherein the first and second pin lock receivers are aligned to receive the pin lock member to lock the movement of the printing bed.

13. The frameless 3D-printing system of claim 1 further comprising a power source with a switch, and a control panel mounted on the mounting plate structure to, respectively power and control the plurality of components.

14. The frameless 3D-printing system of claim 1, wherein the mounting assembly is one of magnetic mounting assembly, or mounting assembly in the form of clips and hangers.

15. The frameless 3D-printing system of claim 1 further comprising a vibration damping members coupled along the back side surface of the mounting plate structure along corners thereof to reduce vibration of the mounting plate structure.

16. The frameless 3D-printing system of claim 1 further comprising a casing having:
a receiving compartment to receive the mounting plate structure to be coupled via the mounting assembly in such a manner that the 3D-printing module is accommodated within the receiving compartment, and
a covering element coupled to the receiving compartment to cover the receiving compartment.

17. The frameless 3D-printing system of claim 1 further comprising a transportation cart, wherein the mounting plate structure is coupled via the mounting assembly over the transportation cart in such a manner that the 3D-printing module is aligned vertically, horizontally or inclinedly on the transportation cart.

18. The frameless 3D-printing system of claim 1, wherein the mounting plate structure to be coupled via the mounting assembly over a vertical wall in such a manner that the 3D-printing module is aligned vertically on the vertical wall.
